(19) United States
(12) Patent Application Publication
(10) Pub. No.: US 2025/0191031 A1
(43) Pub. Date: Jun. 12, 2025

(54) METHOD AND SYSTEM FOR SELECTING DATA RELATED TO A RECIPIENT

(71) Applicant: LastBot Europe Oy, Oulu (FI)

(72) Inventor: Tero Heinonen, Sacramento, CA (US)

(73) Assignee: LastBot Europe Oy, Oulu (FI)

(21) Appl. No.: 18/971,247

(22) Filed: Dec. 6, 2024

Related U.S. Application Data
(60) Provisional application No. 63/606,661, filed on Dec. 6, 2023.

(51) Int. Cl. G06Q 30/0251; G06F 16/22; G06N 20/00; G06Q 30/015

(52) U.S. Cl. CPC G06Q 30/0271; G06F 16/2237; G06N 20/00; G06Q 30/015

(57) ABSTRACT

A method, system, and computer program for selecting data related to a recipient, enabling highly personalized and data-driven interactions. The method includes obtaining and normalizing diverse data sets, generating vectorized embeddings, and producing output data sets including candidate outputs tailored to the recipient. Advanced machine learning models analyze and compare embeddings to select optimal outputs based on predefined criteria. The system includes modules for data acquisition, normalization, embedding generation, and dynamic output selection, ensuring scalability and real-time adaptability.

### TECHNICAL FIELD

The present disclosure relates generally to machine learning; more specifically, the present disclosure relates to a system and a method for selecting data related to a recipient.

### BACKGROUND

Efficient customer communication is important across industries for all entities such as companies, enterprises, and businesses. Yet determining optimal message content, product recommendations, and customer targeting for key initiatives such as sales, marketing, and retention poses a persistent challenge. The complexity of identifying ideal solutions for countless customer-product-message-outcome combinations exceeds human data processing capabilities. Recent advancements in Artificial Intelligence (AI) offer potential solutions. For example, Large language models (LLMs) like GPT facilitate scalable natural language generation, while multilayer perceptrons (MLPs) quickly learn complex representations. Integrating these technologies into a Reinforcement Learning (RL) system holds promise for AI-driven marketing and sales automation, continuously improving customer interactions.

Several solutions explore AI's role in enhancing marketing and sales, focusing on specific aspects of customer interaction. However, a comprehensive business optimization framework is lacking, particularly in data efficiency, multi-turn dynamics for dialog policy learning, and integrating domain ontology into dialog systems. Deep RL is acknowledged for constructing intelligent autonomous systems in Conversational AI. A Chatbot conversational model, leveraging contextual information for accurate responses, demonstrates RL's better alignment with human preferences compared to supervised methods.

Meta-learning for NLP illuminates task construction settings and applications, especially in recommendation systems, where RL optimizes long-term user engagement. Despite these techniques, a combination of optimizing messaging, products, targeting, and business objectives remains unexplored in prior systems.

Therefore, there is a need to address the aforementioned technical drawbacks in existing technologies in selecting data related to a recipient.

### SUMMARY

The aim of the present disclosure is to provide a method and system for selecting data related to a recipient. The aim of the disclosure is achieved by the method and system which selects data related to the recipient as defined in the appended independent claims to which reference is made to.

Embodiments of the present disclosure dynamically improve enterprise sales, marketing, and customer service. The present disclosure can efficiently sample high-performing messages, train from each customer interaction, and drive measurable gains on key business metrics. Additionally, the present disclosure provides for example an artificial intelligence (AI)-based customer communication automation for entities (e.g., enterprises, and other organizations), proving its effectiveness over time by accelerating revenue growth and enhancing customer lifetime value. These and other aspects of the disclosure will be apparent from the implementation(s) described below.

### BRIEF DESCRIPTION OF DRAWINGS

Implementations of the disclosure will now be described, by way of example only, with reference to the accompanying drawings, in which:

FIG. 1 is an exemplary diagram of a method that illustrates relations and interactions between a recipient and an entity (e.g., a business enterprise) in accordance with an implementation of the disclosure;

FIG. 2 is an exemplary view of a method for selecting data related to a recipient in accordance with an implementation of the disclosure;

FIG. 3 illustrates an exemplary view of a method for implementing reinforcement learning to continuously optimize recipient sales dialog in accordance with an implementation of the disclosure;

FIG. 4 illustrates an exemplary view of a method for handling unstructured data in accordance with an implementation of the disclosure;

FIG. 5 illustrates an exemplary view of a method for handling missing data in accordance with an implementation of the disclosure;

FIG. 6 illustrates an exemplary view of a method for normalizing data and feature extraction in accordance with an implementation of the disclosure;

FIG. 7 illustrates an exemplary view of a method for representing data in accordance with an implementation of the disclosure;

FIG. 8 illustrates an exemplary view of a method for representing outcomes in accordance with an implementation of the disclosure;

FIG. 9 illustrates an exemplary view of a method for learning recipient behavior in accordance with an implementation of the disclosure;

FIG. 10 illustrates an exemplary view of a method for caching of data in accordance with an implementation of the disclosure;

FIG. 11 illustrates an exemplary view of a method for approximation of embeddings in accordance with an implementation of the disclosure;

FIG. 12 illustrates an exemplary view of a method for continuous training of a Machine learning (ML) model in accordance with an implementation of the disclosure;

FIG. 13 illustrates an exemplary view of a method for continuous training optimization of the ML model in accordance with an implementation of the disclosure;

FIG. 14 illustrates an exemplary view of a method for sampling of messages in accordance with an implementation of the disclosure;

FIG. 15 illustrates an exemplary view of a method for iterating data inputs in accordance with an implementation of the disclosure;

FIG. 16 illustrates an exemplary view of a method for privacy, compliance, and universal training in accordance with an implementation of the disclosure;

FIG. 17 is flow diagram that illustrate a method for selecting data related to a recipient in accordance with an implementation of the disclosure; and

FIG. 18 is an illustration of a computer system (e.g., a system) in which the various architectures and functionalities of the various previous implementations may be implemented.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

According to a first aspect, there is provided a method for selecting data related to a recipient, the method comprising: obtaining a plurality of data sets; enriching data of the plurality of the data sets; normalizing the data of the plurality of the data sets; forming embeddings of the normalized data; and using machine learning to find from the embeddings a target embedding for a target recipient.

More specifically, in an embodiment of the present disclosure, the method for selecting data related to a recipient comprises obtaining one or more data sets; processing the data within the one or more data sets to extract and normalize content into normalized attributes; generating vectorized embeddings of the normalized attributes; producing an output data set comprising one or more candidate outputs for interaction with the recipient; generating vectorized embeddings of the one or more candidate outputs; comparing the vectorized embeddings of the normalized attributes and the vectorized embeddings of the one or more candidate outputs; and selecting zero or more candidate outputs from the output data set based on a predefined selection criterium applied to the comparison results.

The method enables to optimize interactions between an entity (e.g., a business) and a recipient (e.g., a customer) by selecting the most relevant data-driven outputs, such as personalized messages or recommendations aligned with the recipient's preferences or needs. This enables businesses to automate, refine, and personalize their communication and decision-making processes, making interactions more effective and meaningful. This is particularly valuable in scenarios like marketing, customer support, or product recommendations. The method enables to processes and normalizes data from various formats and sources, making it usable for machine learning. By using embeddings, it captures relationships within data, enabling precise matching of recipient attributes with potential outputs. The method further enables to dynamically select optimal outputs based on predefined criteria, allowing for real-time, customized interactions. Thus, the method enables to handle large-scale data and interactions efficiently, making it suitable for complex and evolving use cases.

Obtaining one or more data sets involves gathering relevant data from various sources. The data sets may comprise structured and/or unstructured data. These data sets may include information about the recipient, transactions, prior communications, or other contextual factors. By collecting this data, the method ensures a comprehensive foundation to understand the recipient's preferences and behavior. This creates the foundation for bringing together all relevant information for further analysis.

In the step of processing the data to extract and normalize content into normalized attributes the collected data is cleaned, structured, and standardized. The normalized attributes may be for example purchase history, communication history, demographic information, interests, decision-making style, values, self identity, email address, weight, income level, marital status, product features, brand values, brand tone of voice, etc. I.e., anything about brand, product, deal, offer, product, consumer, customer, including current and historical data. The method uses techniques like removing irrelevant information, handling inconsistencies, and converting diverse data formats into a uniform structure, i.e., into normalized attributes. The normalization ensures that the data is ready for machine learning processes, making it easier to analyze and compare effectively, regardless of its original format or source.

In the step of generating vectorized embeddings of the normalized attributes the normalized data is transformed into numerical representations, i.e., embeddings. These embeddings capture the meaning of the data in a way that can be processed by machine learning models. Embeddings allow complex relationships and patterns in the data to be encoded into a machine-readable format, making it possible for AI models to understand and analyze the data efficiently.

In the step of producing an output data set comprising one or more candidate outputs for interaction with the recipient, the system is configured to generate and/or select, based on the embeddings, a list of potential outputs or suggestions. These may be personalized messages, product recommendations, or any other interaction tailored to the recipient. This enables to create actionable insights and possibilities for engagement, ensuring that the next interaction aligns closely with the recipient's needs and context.

In the step of generating vectorized embeddings of the one or more candidate outputs the candidate outputs are transformed into a second set of embeddings. This ensures that the system can perform meaningful comparisons between the recipient's attributes and the potential outputs. By embedding the outputs, the method makes it possible to evaluate the compatibility between the recipient's needs and the suggested interactions.

Comparing the vectorized embeddings of the normalized attributes and the candidate outputs involves analyzing the similarity or relevance between the recipient's data (normalized attributes) and the proposed outputs. This ensures that the system identifies outputs that are most aligned with the recipient's preferences or expected outcomes, prioritizing relevance and effectiveness. In the comparison predefined criteria, such as closeness in embedding space, to rank or evaluate the outputs, may be used.

Selecting zero or more candidate outputs based on predefined criteria enables the system to chooses one or more outputs from the list of candidates, or none if no suitable match is found. This selection is based on the comparison results and specific rules defined by the system. This provides a filtered, optimized, and contextually relevant output that is ready for interaction with the recipient, ensuring high-quality and impactful engagements.

The one or more data sets may include personal data, transaction data, recipient data, marketing data, support data, partner data, and public data. Optionally, the one or more data sets include unstructured text, including product descriptions, recipient history, messaging, etc.

Optionally, the method may further comprises enriching the data of the one or more data sets using external data sources or internal data sources. In such embodiment, the method enriches the data of the one or more data sets using a data enrichment layer. The enrichment of the data includes adding inputs to the data enrichment layer with additional data. The additional data may be obtained from at least one of an external data source, or an internal data source. The enrichment of the data is a computational step that includes querying the internal data source or the external data source and its caches. The additional data is added to the input of the data enrichment layer if the additional data corresponding to any of the inputs is identified based on the computational step. For example, a third-party device may provide attributes related to the recipient, or alternatively, there may be a cache of recent contextual actions that can be added to the additional data. Optionally, the additional data is represented and concatenated in natural language.

Enriching the one or more data sets may include at least one of: search engine search, social media search, web scraping, or database querying. Enriching the data sets with such data sources improves the completeness, relevance, and context of the data. It adds valuable external or updated information that may not be present in the original data sets, leading to more accurate predictions, better personalization, and enhanced decision-making in the system. This ensures the outputs are based on a broader and richer set of insights.

The one or more data sets comprise customer data comprising at least one of: gender, age, address, purchase history, communication history, credit rating, relationship status, or income level. Including such customer data improves the personalization and relevance of the outputs. By using detailed and diverse customer information, the method enables understand better individual preferences, behaviors, and needs, resulting in more tailored and effective interactions that align with the recipient's unique profile.

Additionally or alternatively, the one or more data sets may comprise customer interaction and performance metrics comprising at least one of: purchase data, click-through data, satisfaction metrics, lifetime value, or conversion data. Including one or more of different types of customer interaction and performance metrics improves the predictive accuracy and outcome optimization of the method. These metrics provide actionable insights into customer behavior and engagement patterns, enabling to prioritize interactions that are more likely to yield positive business outcomes, such as increased conversions or improved customer satisfaction.

The method may further comprise assigning weights to data within the one or more data sets based on the time at which the data was generated or occurred. This improves the relevance and timeliness of the method's outputs. It enables to prioritize recent and more contextually relevant information while de-emphasizing outdated or less significant data. This ensures that decisions and interactions are aligned with the most current customer behavior and preferences, leading to more accurate and effective outcomes.

The one or more data sets may comprise at least two types of data selected from text, images, video, or audio. This improves the comprehensiveness and versatility of the method. By processing diverse forms of data, the system can capture richer, multimodal information about the recipient, enabling deeper insights and more nuanced personalization. This adaptability enhances the system's ability to handle a wider range of scenarios and interactions effectively.

The output data set is generated using an AI model comprising at least one of the following: a large language model, a generative AI model, a machine learning model, a transformer model, a diffusion model, or a deep neural network. This improves the accuracy and adaptability of the method. These AI models enable the system to generate highly contextualized, relevant, and creative outputs by leveraging their ability to understand complex patterns, relationships, and contexts within the data. This results in more precise and impactful interactions tailored to the recipient's needs.

Optionally, the AI model may be configured to use at least one data set of the one or more data sets to generate the output data set. Configuring the AI model to use at least one data set from the available data improves the contextual relevance and specificity of the generated outputs. By tailoring the output data set to the specific attributes, preferences, or behaviors found in the input data, the system ensures that its responses or recommendations are better aligned with the unique characteristics of the recipient or situation, resulting in more accurate and meaningful interactions.

In an example of the present method, the method normalizes the data of the one or more data sets using a Large Language Model (LLM) layer. The LLM layer normalizes the data to transform unstructured data and/or structured data into a format that is suitable for further training the ML layer considering interdependencies of the one or more data sets. The normalization of data includes extraction of the normalized data from the unstructured data using (i) the LLM layer and (ii) prompting. The LLM layer may extract key information from the unstructured data into a consistent normalized form using prompts and templates. The prompting may be template-based, dynamic or programmatic.

In the normalization of data, the one or more data sets are referred as, (i) recipient data set (Λ) with individual recipient data represented by λ, (ii) brand, product and deal data set (B), with individual brand, product and deal data represented by β, (iii) contextual data set (Γ), with individual contextual data represented by γ and (iv) message data set (Δ), with individual message data represented as δ. The data sets Λ, B, Γ, and Δ are infinite-dimensional; however, the dimensionality is constrained by practical computing limitations.

The LLM layer normalizes the data to transform each data set Δ, β, γ, and δ into their normalized forms λ′, β′, γ′, and δ′. The LLM layer may include a transformer architecture to employ the normalization process. In addition, the transformer architecture utilizes positional encoding and multi-head attention, thereby enabling processing and semantic encoding of both scalar data and sequential dense or sparse data. For example, the scalar data may include the age of the recipient. For example, the sequential dense or sparse data may include purchase history or prior employment, effectively considering interdependencies and relations within each input. Optionally, the normalization of data is performed using any specific implementation of LLM. Optionally, a plurality of LLM layers (e.g., a Llama-2 70 billion parameter model) are employed to perform the normalization of data. Optionally, two or more of the plurality of LLM layers are used together to normalize the data partially or fully. The plurality of LLM layers may be interchangeable and may be replaced with another LLM from time to time.

The message data set (Δ) may include a discrete set of possible messages that can be communicated with recipients defined for example from a dataset of previous messages with recipients, or previously defined set of messages desired. The discrete set of messages restricts the applicability only to those matters and discussions where a predetermined relevant message is available. The discrete set of message restricts the commercial applicability but at the same time guarantees that the messages are within the desired data set (Δ). Optionally, the LLM layer samples an infinite-dimensional data set to analyze all possible messages corresponding to real-life applications where the messages are not constrained by a predefined set of messages. The LLM layer samples the message data set (Δ). The normalized data λ′, β′, γ′ may be fed in the prompts to the LLM layer together with a prompt. The prompt may include a number and types of desired messages. The LLM layer may generate between 10-1,000 alternative messages; for example, the alternative messages can be 1, 5, 10, 50, 100, 250, 500, or 1000 messages. The LLM layer may generate a plurality of messages as the LLM layer has the benefits of being pretrained with a very large corpus of text covering such a high number of different real-life situations and contexts that a likelihood of at least one of the trained situations or contexts being relevant to the topic matter of the present situation is high, optionally being trained across the one or more data sets, and maintaining control over the sampled distribution.

The LLM layer may generate the plurality of messages by covering different semantic perspectives. The transformer architecture of the LLM layer supports the LLM layer to store previous message suggestions in a context and generates the plurality of messages that differ from the previous message suggestions in the same context. This inherent capability of the LLM layer can be invoked through prompting.

Optionally, to sample further away from the nominal messages a temperature of the LLM token sampling step can be adjusted, and alternative and custom sampling algorithms used and the LLM layer instructed in the context (as part of the prompt) of a desired type of messages and variation. This allows for achieving a targeted distribution of messages in the message data set (Δ), either nearer to or distant from the nominal vector(s).

In addition, individual messages δi during the generation of ordered set of messages δ0, δ1, . . . δN against the prediction model for the predicted outcome for the message δi can be evaluated. This evaluation can be invoked after a new token has been sampled from the logits, when a pattern denoting the end of an individual message is recognized.

The most recent message can then be extracted, the outcome predicted, and value tokens inserted into the output token sequence. These value tokens are configured to instruct the LLM of the expected value of the most recent message. The value tokens may be expressed in natural language, as numerical values encoded into tokens, or as specials tokens reserved for expressing the value. The value tokens are further configured to inform the LLM on the merits of each previously generated message δi. As the LLM attends previously generated messages with their value tokens while generating the next message, the value tokens implicitly help the LLM to guide its search in A towards the desired distribution, for example in the simplest case towards the highest predicted value.

This is favorable in comparison to explicit planning or search algorithms of the Δ as the present approach implements iteratively optimizing search of the message data set (Δ) implemented solely in the token sequence space without the need for explicit search algorithms or higher-level abstractions such as trees of thoughts.

Further benefit of this approach for sampling and search is that as it relies on the basic characteristics of modern LLMs it directly benefits from any accelerations of the inference frameworks such as speculative sampling, optimization of attention and linear layers, distilled and sparse models.

The evaluation and injection of value tokens can be performed while processing the same token sequence and keeping the transformer state resident in the GPU, resulting in O(n2) time complexity with respect to the number of messages n or more precisely the token length of these messages. This is much favourable to a scenario where the sequence would be restarted separately for each message prompted by all previous messages, where the time complexity is O(n3). Also, any optimization of the LLM transformers algorithm such as sparse attention or parallel processing which can reduce O(n2) time complexity will directly benefit the resent system correspondingly.

For practical implementation, the number of messages N to meet the real-time requirements of the current use case can be adjusted. A lower N will mean reduced exploration of the message data set (Δ) and higher N will result in expanded exploration.

For example, for an interactive voice response, 50 ms for generating the candidate messages may be allocated and choosing the optimal message and set N=10, while for an email response N=1,000 to optimize between the response time and coverage of search may be chosen. Even at the limit of N=1 the sole sampled message is reasonable and useful as it is conditioned on the in-context information λ′, β′, γ′ that the LLM can leverage applying its learned information. Besides the time complexity, another practical upper limit for N is the context window of the LLM, or in the era of extended context windows (such as through fractional positional encodings) the effective context length which still provides sufficient recall, for example 2k tokens for Llama 2 7B, 24 k for Claude 2.1, and 64 k for OpenAI's GPT4Turbo. As the LLM is used as a sampler, the present method also tolerates less than perfect recall allowing the use of extended context window.

It is important to note that as a sampler of the message data set (Δ) in the context of the RL framework, the goal of sampling is not to maximize expectation but provide a controllable method to manage the sampled distribution to reach the desired balance between exploitation and exploration.

The LLM layer is utilized as an efficient sampler of the message data set (Δ), where the distribution of samples is shaped with one or more control parameters and achieved desired properties of the output distribution with a sample efficient method.

The method may sample the brand, product, and deal data set (B) from at least one of an enumerated discrete data set or a generated infinite data set. For example, the enumerated discrete data set can be a product inventory. Further, the method may analyze new products or deals, or changes to existing products. The method may analyze whole product portfolios, bundling, pricing models, etc.

The method may use generative capabilities of the LLM layer to analyze the brand, product, and deal data set (B) to support a new product introduction, market demand analysis, segmentation, and simulation. For example, the method may sample all existing products against all known recipients and select an optimum message for each recipient. This enables not only determining the optimal message, but also the optimal customer-product-message combinations. Alternatively, the method defines a new product by creating its textual description and verifies the new product with a defined segment of the recipients. The method may simultaneously optimize each message for each individual recipient which provides unprecedented capabilities to the method to evaluate new products, offerings, and bundles against trained data. This insight informs product management, marketing, and enterprises of how their recipients may respond to new ideas and offerings, and where they have to target their product.

The method forms embeddings of the normalized data, e.g., a first embedding, a second embedding, and a third embedding of the normalized data. The method may embed the normalized data into fixed-dimension dense vector representations using the LLM layer as fixed feature extractors.

The normalized data λ′, β′, γ′, and δ′ may be projected into fixed-length embedding data sets using an encoder or encoder-decoder LLM or its derivatives. For example, the encoder-decoder LLM can be Bidirectional Encoder Representations from Transformers (BERT). The encoder-decoder LLM may map textual presentations into an embedding data set subject to a semantic proximity condition. These embeddings are then combined into a joined embedding vector in a predetermined order. The joined embedding vector may represent a specific transformed and normalized data point.

For example, let Σ represent R^{d} data set of all embeddings. The individual embedding vectors within this data set may be represented by a with a subscript to denote specific vectors (e.g., σ₁, σ₂, . . . , σₙ).

In case there are multiple recipients λ, brands, products and deals β, contextual data γ, and messages δ, the σ ca be created for all combinations or a desired subset of combinations of them leading to a total of n embedding vectors σ₁, σ₂, . . . , σₙ and a machine learning step is applied separately for each of them.

The method uses machine learning to find from the embeddings a target embedding for a target recipient. A Machine Learning (ML) layer that is trained with data points to optimize specified outcomes (i.e. expected outcomes). The data points may be created from an encompassing reinforcement learning framework. The ML model is trained using customary training methodologies and algorithms. The ML model may obtain the embeddings, e.g., the first embedding, the second embedding, and the third embedding as inputs in Σ data set that includes recipient, brand, product, deal, context, and message data. The ML model may be trained based on an output of the embeddings and may predict a sum of outcomes of a specific message delivered to a specific recipient at that moment and in the presence of contextual data. The outcomes may be defined by the entity and they apply to a specific recipient. For example, the outcomes may include purchases, clicks, satisfaction metrics, lifetime value, or other metrics. Each outcome has an associated economic value, which may be positive, zero, or negative. The value associated with an outcome may be derived from the business strategy, marketing and sales objectives, business KPIs, financial objectives, or similar metrics of the entity.

The ML model is continuously trained based on prior outcomes in the background. Optionally, the ML model is continuously retrained by incorporating new outcomes trained into the ML model in near real-time.

The method according to the present disclosure optimizes communications and interactions with the recipients, e.g., customers or users in real-time. The method may employ an advanced reinforcement learning (RL) framework that leverages large language models (LLMs) and continuously trained machine learning (ML) model for example deep multilayer perceptron (MLP) networks to optimize messaging, product recommendations, and recipient, e.g., a customer is targeted to maximize the specified outcomes (e.g., business outcomes). The method may implement machine learning ML using other methods comprising of support vector machines, decision-trees, random forests, gradient boosting machines, K-nearest Neighbors (kNN), naïve bayes, logistic regression, linear regression, principal component analysis (PCS) or other deep learning models than MLP.

The method may enable a customer dialog using a partially observable Markov Decision Process (MDP), where the method maximizes an expectation or another desired function of cumulative outcome distribution.

The method dynamically improves enterprise sales, marketing, and customer service. The method can efficiently sample high-performing messages, train from each recipient interaction, and drive measurable gains on key metrics related to the business. The method provides an artificial intelligence (AI)-based customer communication automation for entities, proving its effectiveness over time by accelerating revenue growth and enhancing customer lifetime value. The method integrates LLMs for message generation and data normalization with an efficiently trained ML for real-time training and inference. The method enables easy integration of new data sources, the new outcomes, and LLMs to accommodate evolving business needs.

The method achieves efficient machine learning through normalization and embedding steps, which facilitate the utilization of standard ML architectures such as MLP. Alternative input formats and contents may be abstracted into a fixed-dimensional dense semantic vector data set. The normalization of data may handle missing data by reconstructing, approximating, or estimating it from existing data, or representing it in a consistent encoding in an embedding data set. As a result, the method integrates the missing data into a parallel online training pipeline, eliminating the need for explicit handling of missing data at subsequent stages.

The method performs parallel continuous automated training and continuous deployment that enable ML model improvement without downtime or human interaction. The method performs continuous retraining to improve the performance of the ML model even in the absence of new outcomes since the previous retraining. The lack of outcomes serves also as new information that improves the ML model's performance. For example, if the recipient continues to not respond to a cold email, the ML model may change the expected value of similar messages in the same situation.

The method may be characterized as a Reinforcement Learning (RL) technique to train the LLM layer based on an optimal policy that maps states to actions that maximize an expected cumulative reward over time. The adaptive nature of the RL and the ML is combined to train the LLMs, thereby allowing the method to manage the complexity of real-world business environments. The dynamically trained ML may serve as a value function approximator in the observable Markov Decision Process (MDP). The MDP involves partial observability, with explicit states, e.g., context, while the recipient's mental processes remain unobservable.

In an example, the following may be defined.

State S is the state of the current communication context, including λ′, β′, γ′, and δ′.

Action A is the message Δ(ω)=δ that is selected based on the state S.

Optimal Policy is a stochastic policy for choosing an Action from a distribution of potential actions. The policy maps the State S into action A by first generating an ordered set of candidate messages using LLM δ₀, δ₁, . . . δ_{N}, where each message δᵢ is conditioned to the State a and previous messages δ₀, δ₁, . . . δᵢ₋₁ and the corresponding predicted Rewards R r₀, r₁, . . . , rᵢ, and secondly stochastically selecting a message δ by applying a stochastic sampling function on the R distribution selecting R(ω)=r and δ=δₗ.

Reward predictor R\hat{ }(S, δ) is a known ML model for example a deep neural network that is used to learn optimal mapping from state S and a message δ to Reward R.

Reward or value function R is the sum of business outcomes each as discounted to the time of the message

$$\sum ( {Value}_{outcome} f ( {T}_{outcome} - {T}_{message} ) ) .$$

Thereby result is a combination of the following strategies. Neural-Fitted Algorithms, where the ML is the continuously learned part of the system, which learns to map message δ to Reward R conditional to State S. Policy Iteration, where the R\hat{ } is continuously learned and retrained for every additional tuple S, δ, r.

MCMC sampling of the candidate messages δ₀, δ₁, . . . δ_{N} for each State S where each message δᵢ is conditioned to the previous messages and their predicted Reward R and are selected stochastically in a Markov Chain process.

Thus, the present method and system does not learn policy selection function directly, instead it learns Reward function predictor R\hat{ }. Consequently there are no direct RL hyperparameters to the learning such as learning rate or discount factor and effectively hyperparameters are implicit in the deep neural network implementing the R\hat{ }. The present method and system uses MCMC sampling to explore the message data set (Δ) conditioned also predicter rewards r₀, r₁, . . . , rᵢ from the reward predictor R\hat{ }. The real State Sᵣₑₐₗ is partially and weakly observable as that also includes the state of mind of the end-customer which is only indirectly and partially observable in the State S. The real State Sᵣₑₐₗ is also continuously affected by actions outside the method and system described herein.

The method can sample the message data set Δ efficiently and controllably in proximity to nominal vectors, thereby enabling improved performance even at the beginning of training. The method exhibits performance akin to human capabilities even in the absence of explicit training data, leveraging the inherent training embedded within the LLMs, which are employed for message sampling.

The method may use pre-trained LLM models, thereby eliminating the need to subject the LLM for training or fine-tuning and the risk of data leakage between different customer environments through the LLMs.

The method may wholly or partially train or fine-tune the LLM models using the ML estimate to improve the LLM model responses. The method may connect the LLM and ML into a single model, where all the weights of the model are trained together. The method may freeze some layers of the LLM while training some other layers. The method may implement one or a plurality of LoRA (Low-Rank Adaptation of Large Language Models) to fine-tune the LLM model behavior and outputs using a lightweight technique, that significantly reduces the number of trainable parameters.

The machine learning model (ML) such as multilayer perceptron (MLP) model is built within a robust security infrastructure, ensuring its operation remains confined to authorized usage. This encapsulated environment for the ML model reinforces security protocols, making the method a reliable solution for handling and processing sensitive data without compromising the privacy or data integrity of the recipient information.

Optionally, the method comprises repeating the steps iteratively to account for changes in the one or more data sets. Repeating the steps iteratively to account for changes in the data improves the adaptability and responsiveness of the method. It ensures the system remains up to date with evolving data, such as shifting customer preferences or new contextual information. This iterative approach enables the method to continuously refine its outputs, maintaining relevance and accuracy over time. The changes in the one or more data sets refer to additions, updates, modifications, or removal of information within the one or more data sets.

According to the different embodiments of the present disclosure, the method may further comprise one or more of the following: using the desired output data for communication with the recipient in at least one of: email, text message, or web page; using in the normalization of unstructured data at least one AI model comprising at least one of the following: a large language model, a generative AI model, a machine learning model, a transformer model, a diffusion model, or a deep neural network; handling missing data by generating embeddings for the missing data using at least one AI model comprising at least one of the following: a large language model, a generative AI model, a machine learning model, a transformer model, a diffusion model, or a deep neural network; receiving one or more outcome data sets and conditioning an AI model comprising at least one of the following: a large language model, a generative AI model, a machine learning model, a transformer model, a diffusion model, or a deep neural network using at least one of the outcome data sets and at least one of the one or more data sets; tracking information associated with the recipient and incorporating the tracked information into the one or more data sets; using at least one of the one or more data sets for conditioning an AI model comprising at least one of the following: a large language model, a generative AI model, a machine learning model, a transformer model, a diffusion model, or a deep neural network; anonymizing or pseudonymizing recipient-specific data in the one or more data sets; obtaining feedback from the recipient and incorporating the feedback into the one or more data sets; performing at least one of the normalization steps or the embedding step using one or more of batch processing, asynchronous processing, or parallel processing to efficiently handle large data sets; segmenting recipients based on the one or more data sets into groups of recipients with similar characteristics; updating the AI model by training it incrementally using newly obtained data without performing complete retraining; forming clusters of similar embeddings to optimize the comparison and selection of the desired output data; storing embeddings of frequently accessed data to reduce computational overhead during repeated comparisons; dynamically updating the selected desired output data during ongoing interactions with the recipient to provide real-time recommendations or responses.

Using the desired output data for communication with the recipient in at least one of: email, text message, or web page enhances the practical applicability of the method by enabling direct communication through commonly used channels. This ensures seamless implementation in real-world scenarios and supports personalized, context-aware interactions.

Using in the normalization of unstructured data at least one AI model increases accuracy and efficiency in handling diverse data types. By leveraging advanced AI models, the method can process unstructured data more effectively, enabling consistent and usable outputs for further analysis.

Handling missing data by generating embeddings for the missing data using at least one AI model improves the robustness and completeness of the system. This allows the method to address gaps in data without manual intervention, ensuring that missing information does not degrade the quality of outputs or decision-making.

Receiving one or more outcome data sets and conditioning an AI model using at least one of the outcome data sets and at least one of the one or more data sets enhances learning and adaptability by using outcome data to refine the model. This ensures that the system evolves based on actual performance, leading to more accurate predictions and improved recommendations over time.

Tracking information associated with the recipient and incorporating the tracked information into the one or more data sets improves personalization and context-awareness by maintaining a record of recipient interactions. This allows the system to adapt dynamically to individual behaviors and preferences for more relevant outputs. The tracked information associated with the recipient may be actions, events, or changes associated with the recipient.

Using at least one of the one or more data sets for conditioning an AI model ensures contextual accuracy by fine-tuning the AI model with specific data sets. This enhances the relevance of generated outputs, aligning them with the intended use case or recipient profile.

Anonymizing or pseudonymizing recipient-specific data in the one or more data sets strengthens privacy and compliance with data protection regulations. It enables secure handling of sensitive information, ensuring trust and adherence to legal standards without compromising functionality.

Obtaining feedback from the recipient and incorporating the feedback into the one or more data sets enables continuous improvement and enhances accuracy by integrating feedback loops. This allows the method to refine its outputs and better align with recipient preferences and expectations.

Performing at least one of the normalization steps or the embedding step using one or more of batch processing, asynchronous processing, or parallel processing to efficiently handle large data sets enhances scalability and speed by optimizing data processing. This ensures the method can handle large and complex datasets efficiently, meeting the demands of real-time applications.

Segmenting recipients based on the one or more data sets using vectorized embeddings into groups of recipients with similar characteristics improves targeting and efficiency by clustering recipients into meaningful segments. This enables more focused and relevant communication, increasing the likelihood of positive outcomes.

Updating the AI model by training it incrementally using newly obtained data without performing complete retraining ensures responsiveness and efficiency by allowing updates without full retraining. This enables the system to stay current with new data while minimizing computational overhead.

Forming clusters of similar embeddings to optimize the comparison and selection of the desired output data enhances efficiency and precision by reducing computational complexity. Clustering similar embeddings allows for quicker comparisons, improving response times without sacrificing accuracy.

Storing embeddings of frequently accessed data to reduce computational overhead during repeated comparisons improves processing efficiency by caching frequently used embeddings. This reduces redundant computations, speeding up the system's performance while conserving resources.

Dynamically updating the selected desired output data during ongoing interactions with the recipient to provide real-time recommendations or responses increases real-time responsiveness and relevance by adjusting outputs dynamically based on current interactions. This ensures the system adapts to live inputs, enhancing the effectiveness of the engagement.

While each of these features contributes to making the method and system more robust, efficient, and adaptable, combining these features provide additional synergistic effects that amplifies the system's overall capability. Such embodiments may comprise following examples.

An embodiment comprising handling missing data by generating embeddings, using advanced AI models for normalization of unstructured data, and dynamically updating selected output data during ongoing interactions allows the system to function robustly even in real-time scenarios with incomplete or unstructured data. The ability to dynamically adapt outputs while seamlessly filling data gaps ensures high responsiveness and accuracy, even in unpredictable situations, such as live customer support or evolving user preferences. The system essentially becomes self-healing, maintaining functionality without manual intervention.

Another embodiment comprising tracking information associated with the recipient and incorporating it into data sets, segmenting recipients into groups with similar characteristics, receiving and using feedback to refine data sets and models enable the system to learn and adapt both at the individual and group levels. It can personalize interactions while discovering new patterns and insights from aggregated feedback, creating a self-optimizing system. For example, feedback from one segment can refine predictions for another, improving personalization even for new recipients with minimal historical data.

Another embodiment comprising storing embeddings of frequently accessed data to reduce overhead, forming clusters of similar embeddings, incrementally updating AI models without full retraining drastically reduces computational overhead while maintaining model freshness. The system can handle large, dynamic datasets by focusing computational resources on high-value updates and recurring patterns. The surprising result is a system that scales effortlessly without degrading performance, even with growing data and usage.

Another embodiment comprising anonymizing or pseudonymizing data, using outcome data sets to condition AI models, obtaining feedback to refine data sets ensures privacy compliance while simultaneously enhancing model learning. The ability to anonymize data yet still extract meaningful insights enables organizations to use aggregated behavioral data across customers or recipients without risking sensitive information exposure. This unlocks a broader training dataset, leading to more accurate models and better predictions than would be possible with isolated, raw data.

Another embodiment comprising using embeddings for both recipient data and output data, comparing embeddings to select outputs, iteratively refining steps to account for data changes creates a system that can anticipate trends and behaviors in real time. For example, the system can predict shifts in recipient preferences by analyzing subtle changes in embeddings over time, enabling proactive adjustments before explicit feedback is even provided.

Another embodiment comprising receiving feedback from recipients, normalizing unstructured data with AI models, producing dynamic updates to outputs during interactions allows the system to adjust not only to current interactions but also to underlying patterns across interactions. The system can detect and incorporate behavioral trends into outputs dynamically, leading to highly tailored responses that feel uniquely intelligent to users.

According to a second aspect, there is provided a system for selecting data related to a recipient, the system is configured to obtain one or more data sets; enrich data of the one or more data sets; normalize the data of the plurality of the data sets; form embeddings of the normalized data; and use machine learning to find from the embeddings a target embedding for a target recipient.

More specifically, the system for selecting data related to a recipient, the system comprising: one or more processors configured to perform the steps of the method according to any one of the present embodiments; a data acquisition module configured to obtain one or more data sets; a data normalization module configured to process the data within the one or more data sets to extract and normalize content into a normalized attributes; an embedding module configured to generate vectorized embeddings of the normalized attributes; a data generation engine configured to produce an output data set comprising one or more candidate outputs for interaction with the recipient; a comparison module configured to compare the vectorized embeddings of the normalized attributes and the vectorized embeddings of the one or more candidate outputs; and a selection module configured to select zero or more candidate outputs from the output data set based on a predefined selection criterium applied to the comparison results.

The system is designed to select data tailored to a recipient by combining modular components that execute the steps of the present method. It comprises one or more processors to manage the operations and a data acquisition module to collect relevant data sets. A normalization module prepares this data for analysis by extracting and standardizing attributes, while an embedding module converts the normalized data into machine-readable vector formats. Using these embeddings, the data generation engine creates candidate outputs, and the comparison module evaluates their relevance. Finally, the selection module filters the candidates to provide the most suitable output based on predefined criteria, ensuring precise and context-aware interactions with the recipient.

The system may be designed with a high degree of integration and interoperability, making it an addition to existing enterprise ecosystems. The system may interface with Customer Relationship Management systems (CRMs), Enterprise Resource Planning systems (ERPs), Customer Data Platforms (CDP), and other data platforms through its simple integration protocols employing various tools and methodologies.

The system may perform flexible content handling based on free formatted natural language text, eliminating the need for extensive data mapping. The sole exception pertains to identity information related to recipients, products, and deals which requires mapping to ensure precise data correlation and integrity. This streamlined integration approach not only facilitates smooth interoperability but also expedites the deployment process, enabling organizations to leverage the system's capabilities within their operational framework.

The system may incorporate several optimizations aimed at enhancing performance. These optimizations comprise of caching intermediate data and results, storing intermediate data in the GPU, employing sampling strategies, quantizing LLM weights and activations, and utilizing cached and approximated predictions. The system may employ keyword searches, structured data searches, and semantic searches for data enrichment. In generative AI literature, the semantic searches complementing data are often called Retrieval-Augmented Generation (RAG). In the system, the results of RAG are appended to each text λ, β, γ and processed further according to the method as described in the first aspect.

Furthermore, the system supports the ingestion of images as input, similarly to text, for the parameters λ, β, γ, and δ. The system may project the images into the embedding data set using a multimodal encoding or encoding-decoding LLM capable of handling both text and images within the same embedding data set. Similarly, with the expansion of LLM modalities, the system is designed to accommodate various input types, such as video, audio, and 3D models. The system enhances enterprise sales, marketing, service, and more through automated, personalized dialog optimization.

The system addresses domain ontologies across a broad spectrum of human situations and behaviors without explicit modelling. This is achieved through a two-fold approach: firstly the LLMs that normalize data and sample messages are trained on a corpus of data reflecting diverse life situations and have been pre-trained to incorporate domain knowledge. Secondly, the ML is trained to map complex dependencies within the one or more data sets, enabling the system to train and refine previously trained behavioral patterns.

To achieve optimal efficiency, the system can be trained through direct graphics processing unit (GPU) programming, emphasizing efficiency, continuous training, and parallelism. The architecture of the system is specifically designed to leverage the advantages of one or more GPUs in one or more computing nodes connected together, efficiently managing numerous simultaneous transactions through dynamic batching strategies. This optimization ensures that the system operates seamlessly, providing robust performance in a variety of scenarios.

The scalability of the LLM is achieved by scaling the LLM horizontally either as a third-party managed service, or as part of the system in cloud, on-premises or in hybrid or by scaling the system itself horizontally when utilizing an embedded LLM inference engine integrated to other components of the system. The system is designed to provide a flexible deployment architecture that caters to diverse organizational preferences, whether it's on-premises, on cloud platforms, or in a hybrid model. The system may be integrated with various LLMs, which can be either proprietary or open source. These LLMs may be hosted on-premises, in the cloud, or embedded within applications to offer a myriad of configuration possibilities to align with the specific deployment scenario or strategy. The deployment strategy of the system is crafted to meet the stringent requirements of entities in handling sensitive data. The system ensures that the privacy of the recipient is upheld, and data processing occurs within a secure paradigm.

Preliminary results validate the system's ability to efficiently explore a data set of messaging options and train effective messaging policies from responses. Online A/B tests show constant over 100% increase in conversion rate from the system-optimized messaging versus the control. Further, gains are observed when the system flexibly optimizes products, deals, and customer targeting in conjunction with messaging.

The test results confirm that automatically optimizing communications and interactions in a closed-loop system meaningfully improve business metrics.

Optionally, the system may further comprise one or more of the following: a feedback module configured to dynamically adjust embeddings based on real-time interactions with the recipient; a storage module configured to store embeddings of frequently accessed data to reduce computational overhead during repeated comparisons; or a dynamic update module configured to adjust the selected desired output data during ongoing interactions with the recipient to provide real-time recommendations or responses.

The feedback module allows the system to learn and adapt on the fly by incorporating feedback from ongoing interactions. It improves the system's ability to refine outputs in real time, leading to more personalized and accurate recommendations during live engagements. This dynamic adjustment makes the system more responsive to changing contexts or recipient behaviors.

The storage module, by caching embeddings, enables the system to reduce computational overhead and improves efficiency during repeated comparisons. This ensures faster processing times, especially in high-demand scenarios, and conserves resources while maintaining accuracy. It is particularly valuable for real-time applications where performance and speed are critical.

The dynamic update module enables the system to continuously refine and update outputs during an interaction, ensuring that recommendations remain relevant as new information becomes available. It enhances the user experience by providing up-to-date, context-aware suggestions, making interactions more fluid and engaging. This feature is crucial for conversational AI applications or real-time decision-making systems.

Additionally, the data normalization module and the embedding module may be configured to operate in parallel to improve scalability and processing efficiency for large data sets. This enables increased scalability and faster processing of large data sets. By handling multiple tasks simultaneously, the system can efficiently process vast amounts of data without bottlenecks, ensuring timely results. This is particularly beneficial for applications requiring real-time analysis or those involving high volumes of diverse data, such as large-scale customer engagement platforms or dynamic recommendation systems.

According to another aspect, the present disclosure provides a machine-learning model for selecting data related to a recipient, for use in the method of any one of the present embodiments, wherein the machine-learning model comprises structural components configured to generate the recipient related output data, and wherein the machine-learning model is trained to: process vectorized embeddings of normalized attributes and vectorized embeddings of output data sets; compare the vectorized embeddings of the normalized attributes with the vectorized embeddings of the output data sets; and identify desired output data related to the recipient based on the comparison. This machine-learning model enables precise and automated selection of recipient-specific output data by leveraging advanced embedding-based analysis. It is arranged to process vectorized embeddings to uncover complex relationships between recipient data and potential outputs. By comparing these embeddings, the model identifies the most relevant and contextually aligned outputs, enabling personalized and effective interactions. This ensures high accuracy and adaptability, also in dynamic or large-scale scenarios.

According to another aspect, the present disclosure provides a computer-implemented method of training the machine-learning model, the method comprising: obtaining one or more data sets; processing the obtained one or more the data sets to form normalized data; forming embeddings of the normalized data; forming a training data set by associating the embeddings with predefined outcome data sets; training the machine-learning model using the training data set to generate an output data related to a recipient; and updating the machine-learning model using feedback data derived from prior output data. The computer-implemented method of training the machine-learning model enables continuous improvement and adaptability of the system. By forming a structured training data set that links normalized embeddings with predefined outcomes, the model can learn patterns and relationships to optimize its predictions. The inclusion of feedback data ensures that the model evolves based on real-world performance, enhancing accuracy and relevance over time. This iterative training process enables the system to adapt to changing contexts, recipient behaviors, and business needs.

According to another aspect, the present disclosure provides a computer-implemented method of generating a training data set for the machine-learning model, the method comprising: obtaining one or more data sets; obtaining one or more outcome data sets; processing the obtained one or more data sets to form normalized data; forming embeddings of the normalized data; determining association between the embeddings of the normalized data and one or more outcome data sets; creating a training data set comprising the embeddings and associated outcome data sets. The computer-implemented method of generating the training data set enables the creation of a highly structured and relevant dataset that directly links input data to desired outcomes. By associating embeddings of normalized data with outcome data, the method ensures that the training data reflects real-world relationships and performance metrics. This enhances the machine-learning model's ability to learn, predict, and optimize outputs effectively, paving the way for more accurate, context-aware, and outcome-driven decision-making.

According to another aspect, the present disclosure provides a training data set for use in the method of training the machine-learning model comprising: normalized embeddings derived from a one or more data sets; outcome data sets associated with the embeddings. This training data set enables efficient and effective training of the machine-learning model by providing a structured and semantically meaningful foundation. The normalized embeddings ensure consistency and compatibility across diverse data inputs, while the associated outcome data provides clear performance targets. This combination allows the model to learn complex relationships between input features and desired results, leading to improved accuracy, better generalization, and enhanced ability to make precise, outcome-driven predictions.

According to another aspect, the present disclosure provides a use of the method of any one of the present embodiments for at least one of: generating recipient-specific recommendations in customer marketing; personalizing marketing messages based on recipient-specific preferences and behaviors; recommending best products and services based on customer data; determining the next best action with respect to a customer; personalizing web site elements to a specific customer; personalizing emails to a specific customer; personalizing text messages to a specific customer. The use of the method in these embodiments enables highly personalized and contextually relevant interactions across various customer engagement channels. It helps businesses to tailor recommendations, messages, and actions to align with individual customer preferences, behaviors, and needs. This enhances customer experience, drives engagement, and improves conversion rates by ensuring that every interaction, whether through marketing, emails, or text messages, is meaningful and targeted. Additionally, it supports data-driven decision-making for optimizing customer journeys and maximizing business outcomes.

According to another aspect, the present disclosure provides a computer program for selecting data related to a recipient, the computer program comprising instructions which, when executed by a processor, cause the processor to perform the method according to any one of the present embodiments. The computer program enables the automation and efficient execution of the method for selecting data related to a recipient. By embedding the method's instructions into executable code, the program ensures consistency, reliability, and scalability in processing data, generating personalized outputs, and optimizing interactions. It allows for seamless integration into various systems and workflows, enabling businesses to leverage advanced data selection and personalization techniques with minimal manual intervention.

According to another aspect, the present disclosure provides a computer-accessible data storage media storing instructions that, when executed by a processor, cause the processor to perform the steps of the method according to any one of the present embodiments. The computer-accessible data storage media enables the portability and ease of deployment of the method for selecting data related to a recipient. By storing the method's executable instructions, it allows the system to be implemented across various devices and environments. This ensures flexibility, consistency, and accessibility, enabling businesses to integrate the method into their existing infrastructure or deploy it in new setups without requiring extensive reconfiguration.

According to another aspect, the present disclosure provides a computer program product for selecting data related to a recipient, the computer program product comprising one or more computer-accessible data storage medium storing a program code, the program code comprising instructions that, when executed by a processor, cause the processor to perform the method according to any one of the present embodiments. The computer program product enables the comprehensive implementation and distribution of the method for selecting data related to a recipient. By combining a program code with one or more computer-accessible storage mediums, it allows for efficient storage, transfer, and execution of the method across different systems. This ensures seamless integration, scalability, and flexibility, enabling businesses to deploy and operate the method in various environments with minimal effort and high reliability.

### DETAILED DESCRIPTION OF THE DRAWINGS

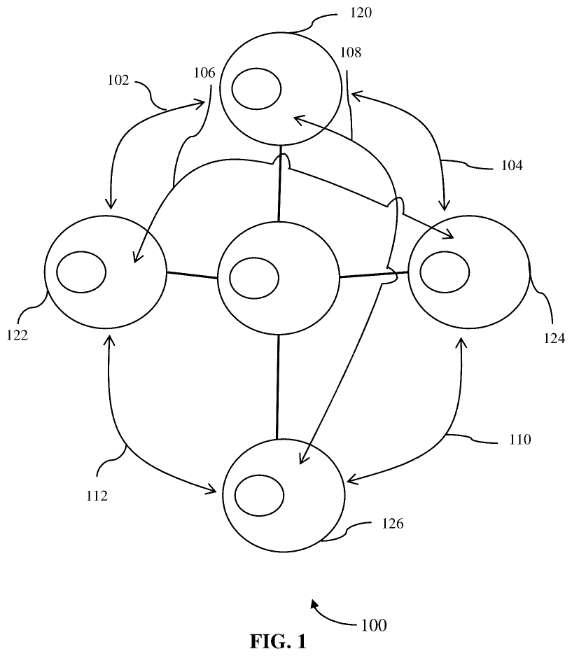

FIG. 1 is an exemplary diagram 100 of a method that illustrates relations and interactions between a recipient and an entity (e.g., a business enterprise) in accordance with an implementation of the disclosure. The exemplary diagram 100 depicts a brand and product affinity mapping 102, a behavioral insight graph 104, a product journey tracker 106, a persona message resonance 108, a context message confluence 110, and a product voice mapping 112. The exemplary diagram 100 further includes a recipient related axes 120, a brand and product dynamics matrix 122, a context matrix axis 124, and a message axis 126. The recipient related axes 120, the brand and product dynamics matrix 122, the context matrix axis 124, and the message axis 126 are correlated based on interactions 102, 104, 106, 108, 110, and 112.

The method continuously and automatically analyses all key relations of recipient communication to train an Artificial Intelligence (AI) model. The method continuously and automatically trains the AI model across one or more recipients, e.g., a user or a customer, and their interactions, thereby accumulating unparalleled business insights that extend across brands, products, segments, and situations of an entity (e.g., a business enterprise). The method may train the AI model based on the relationships to optimize current dialogues and enhance the method's robustness with each interaction. The method is trained and improved continuously, thereby provide unprecedented responsiveness to the changing market conditions and trends.

In the brand and product affinity mapping 102, the method may analyse recipient personas and determines the relation between different recipient personas and one or more brands and products of the enterprise. For example, the one or more brands can be Apple®, Microsoft®, Samsung®, etc. For example, the one or more products can be iPhone, MacBook, ThinkPad, etc. The method may predict a recipient's probability to engage, purchase, or suggest a brand to the recipient using a relation between the recipient personas and the one or more brands and products, thereby enabling the one or more brands to continuously customize their approach for different segments and individual recipients.

In the behavioral insight graph 104, the method may determine the interest of the recipient that corresponds to each purchase, communication, or website visit of the recipient and generates a picture based on the interest of the recipient. The method may determine recipient's needs, preferences, and potential pain points by determining the relation between the recipient's personas and recipient's history.

In the product journey tracker 106, the method may map the one or more brands and the one or more products with contexts of the recipient's history, thereby enabling the one or more brands to strategically position their products, promoting upselling, cross-selling, and maintaining consistent brand narratives.

In the persona message resonance 108, the method may determine optimal messages that resonate with specific recipient personas. The method ensures an alignment between a message and an expectation and an emotional state of the recipient during an event for example a marketing pitch or a support response.

In the context message confluence 110, the method ensures the creation of impactful and resonant dialogues that engage and lead to conversions by aligning messages with a recipient's purchase history, prior communications, and web browsing patterns.

In the product voice mapping 112, the method ensures the consistency of voice with a brand, while also being dynamic to adapt to changing recipient perceptions and market scenarios.

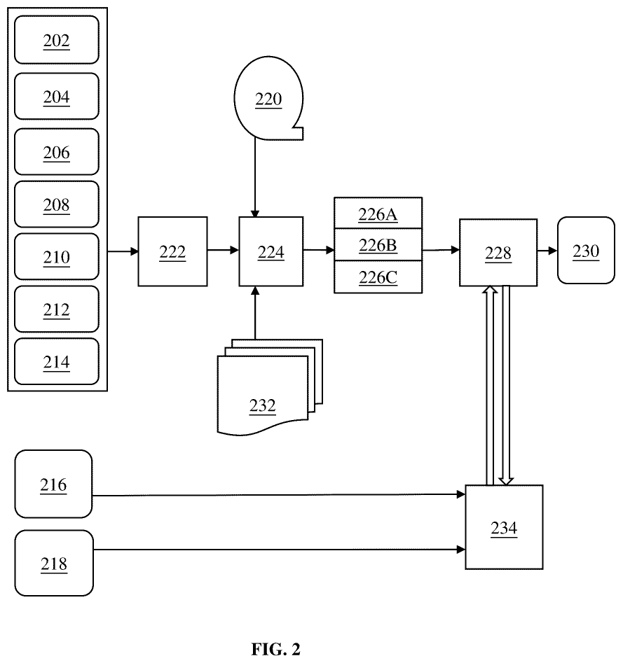

FIG. 2 is an exemplary view of a method for selecting data related to a recipient in accordance with an implementation of the disclosure. The exemplary view depicts personal data 202, transaction data 204, recipient data 206, marketing data 208, support data 210, partner data 212, public data 214, prior outcomes 216, new outcomes 218, prompts 220, a data enrichment layer 222, a large language model (LLM) layer 224, first embedding 226A, second embedding 226B, third embedding 226C, a Machine learning (ML) model 228, expected outcomes 230, templates 232 and a parallel online training pipeline 234. The data enrichment layer 222 obtains data of one or more data sets. The one or more data set may include the personal data 202, the transaction data 204, the recipient data 206, the marketing data 208, the support data 210, the partner data 212, and the public data 214. The data enrichment layer 222 enriches the data of the one or more data sets. The LLM layer 224 normalizes the data of the one or more data sets. The LLM layer 224 may generate a plurality of messages. The LLM layer 224 may extract embeddings. The LLM layer 224 forms embeddings, e.g., a first embedding 226A, a second embedding 226B, and a third embedding 226C of the normalized data. The ML model 228 finds a target embedding for a target recipient from the embeddings, e.g., the first embedding 226A, the second embedding 226B, and the third embedding 226C. For example, outcomes can be revenue growth, profitability improvement, customer satisfaction, productivity, etc. The ML model 228 is trained based on the prior outcomes 216 in in the background. The ML model 228 is retrained by incorporating the new outcomes 218 received from the parallel online training pipeline 234. The ML model 228 is retrained to keep the ML model 228 updated in near real-time. The ML model 228 is continuously trained to predict the expected outcomes 230 of a specific message delivered to the target recipient.

FIG. 3 illustrates an exemplary view of a method for implementing reinforcement learning to continuously optimize recipient sales dialog in accordance with an implementation of the disclosure. The exemplary view depicts first data 302, second data 304, a large language model (LLM) layer 306, first embedding 308A, second embedding 308B, a Machine Learning (ML) model 310, expected outcomes 312, outcomes 314, and a parallel online training pipeline 316. The first embedding 308A is created for the first data 302 and the second embedding 308B is created for the second data 304. For example, the first data 302, and the second data 304 can be data related to one or more products and recipients. The ML model 310 is trained to identify an appropriate message for the expected outcomes 312 from embeddings, e.g., the first embedding 308A, and the second embedding 308B. The LLM layer 306 generates messages for both the first data 302 and the second data 304 separately. For example, the messages can be marketing messages. Optionally, separate embeddings are created for the first data 302, and the second data 304.

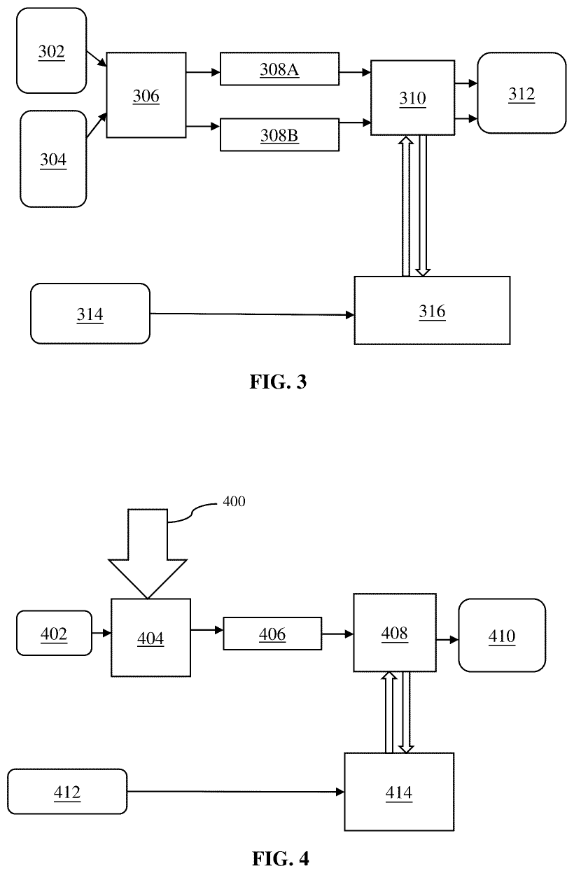

FIG. 4 illustrates an exemplary view of a method 400 for handling unstructured data in accordance with an implementation of the disclosure. The exemplary view depicts data 402, a large language model (LLM) layer 404, embedding 406, a Machine Learning (ML) model 408, expected outcomes 410, outcomes 412, and a parallel online training pipeline 414. The LLM layer 404 is used as a feature extractor to extract unstructured data or structured data, e.g., text, and images. The LLM layer 404 may search, extract, and summarize parameters of each data. The LLM layer 404 applies LLM capabilities such as transformers to understand the interdependencies of the data 402, and to provide normalized data, which is normalized and standardized regardless of each data set. When handling unstructured data, there is no requirement for a developer or a recipient to define or implement mappings or conversions from one or more inputs. The LLM layer 404 can manage an input of any text, thereby enabling scalability to accommodate any recipients, situations, or data types. The LLM layer 404 normalizes the data 402 before it undergoes machine learning applications. This normalization process optimizes the data, addressing its diverse formats, content variations, and disparities. As a result, the LLM layer 404 enhances efficiency, reduces customization efforts, provides adaptability to a changing environment, and accelerates integration and validation timeline.

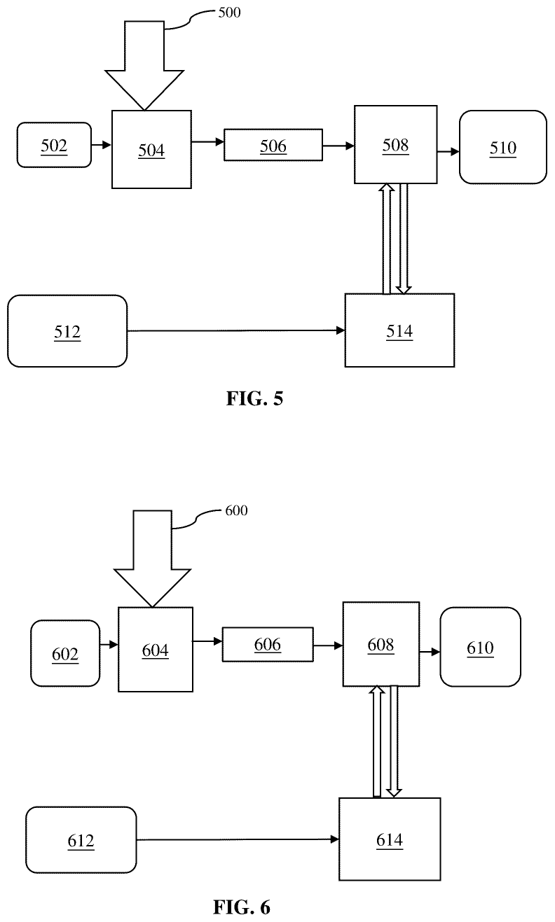

FIG. 5 illustrates an exemplary view of a method 500 for handling missing data in accordance with an implementation of the disclosure. The exemplary view depicts data 502, a large language model (LLM) layer 504, embedding 506, a Machine Learning (ML) model 508, expected outcomes 510, outcomes 512, and a parallel online training pipeline 514. The LLM layer 504 generates values for missing data and derives the missing data from existing data when applicable. For example, if a person's residence is indicated as California, the LLM layer 504 assumes they live in the USA, even if the country is not mentioned. The LLM layer 504 may mark up the missing data as “missing”. When handling the missing data, there is no requirement for developers or recipients to define strategies or policies. The LLM layer 504 handles the missing data and offers scalability across various recipients, situations, or data types without a need for manual intervention, thereby enabling fast deployment and time-to-market for the recipients. Without effective handling, missing data could disrupt machine learning models, preventing them from learning altogether or leading to inaccurate insights. The method can handle the missing data, thereby ensuring the model's robustness, facilitating accurate learning, and enhancing overall performance.

FIG. 6 illustrates an exemplary view of a method 600 for normalizing data and feature extraction in accordance with an implementation of the disclosure. The exemplary view depicts data 602, a large language model (LLM) layer 604, embedding 606, a Machine Learning (ML)model 608, expected outcomes 610, outcomes 612, and a parallel online training pipeline 614. The LLM layer 604 is used as a feature extractor to extract unstructured or structured data, e.g., text, and images. The LLM layer 604 may search, extract, and summarize parameters of each data. The LLM layer 604 applies LLM capabilities such as transformers to understand interdependencies of the data 602, and to provide normalized data, which is normalized and standardized regardless of each data set. For example, a long browsing history is normalized as a statement that summarizes intent of the recipient, instead of a long list of web pages. When normalizing data and feature extraction, there is no requirement for a developer or recipient to define or implement mappings or conversions from various inputs. The LLM layer 604 can manage the input of any text, thereby enabling scalability to accommodate any recipients, situations, or data types. The LLM layer 604 provides a solution for normalizing the data 602 by ensuring compatibility among different data types. This compatibility is important for effective utilization in machine learning processes. The method has the capability to standardize diverse data types with varying structures and lengths optimizes integration process, enabling seamless utilization in machine learning models.

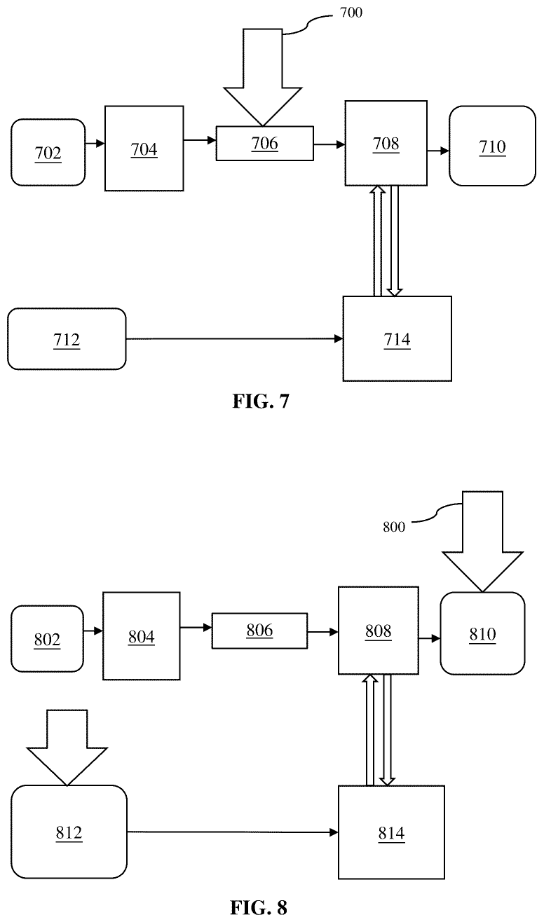

FIG. 7 illustrates an exemplary view of a method 700 for representing data in accordance with an implementation of the disclosure. The exemplary view depicts data 702, a large language model (LLM) layer 704, embedding 706, a Machine Learning (ML) model 708, expected outcomes 710, outcomes 712, and a parallel online training pipeline 714. The method may employ an encoding LLM to individually project each data, e.g., recipient data, contextual data, and product data into an embedding. Each embedding is a vector of predetermined length; for example, embeddings can be of vectors of equal length for example 768 or 1536, where the LLM layer 704 semantically maps data 702 to an embedding 706. Additional scalar values in the data 702 may be appended to an end of the vector in a predetermined position in the vector; for example, the scalar values can be price or a lead time of a product. When representing data 702, there is no requirement for a developer or a recipient to define or implement mappings or conversions from various inputs. The LLM layer 704 can manage the input of any text, thereby enabling scalability to accommodate any recipients, situations, or data types. Even after normalization, some of the data may be a varying type. The method addresses this challenge by representing the data 702 that enables meaningful comparisons between different data types for relative similarity. The method represents each different data into a comparable standardized data set where different data can be compared for semantic similarity.

FIG. 8 illustrates an exemplary view of a method 800 for representing outcomes 812 in accordance with an implementation of the disclosure. The exemplary view depicts data 802, a large language model (LLM) layer 804, embedding 806, a Machine Learning (ML) model 808, expected outcomes 810, outcomes 812, and a parallel online training pipeline 814. The method assigns a value for each outcome event; for example, the outcome event can be purchase, subscription, or cancellation. This is done externally to the method, serving as a parameterization when the method is deployed. For example, in automation of cellular subscription upsells, the value assigned to each purchase reflects an increased price corresponding to a previous one. Similarly, cancellation of a subscription can be assigned a value equivalent to −2 times of the value of a preceding subscription. This valuation aims to incentivize the ML model 808 toward upselling while discouraging actions that might lead to the cancellation of existing subscriptions. Optionally, the outcomes 812 can also be discounted by time. For example, a purchase made today holds a higher value than a purchase in a month. The method can be used in any business optimization process without modifications; for example, the business optimization process can be to optimize conversion rates in a marketing and sales pipeline. Further, representing the outcomes enables scalability to any entity, recipient, situation, or data. The method represents different outcomes in a comparable manner. Hence, the ML model 808 can be trained to optimize the total outcome whether consisting of one or several metrics (KPIs).

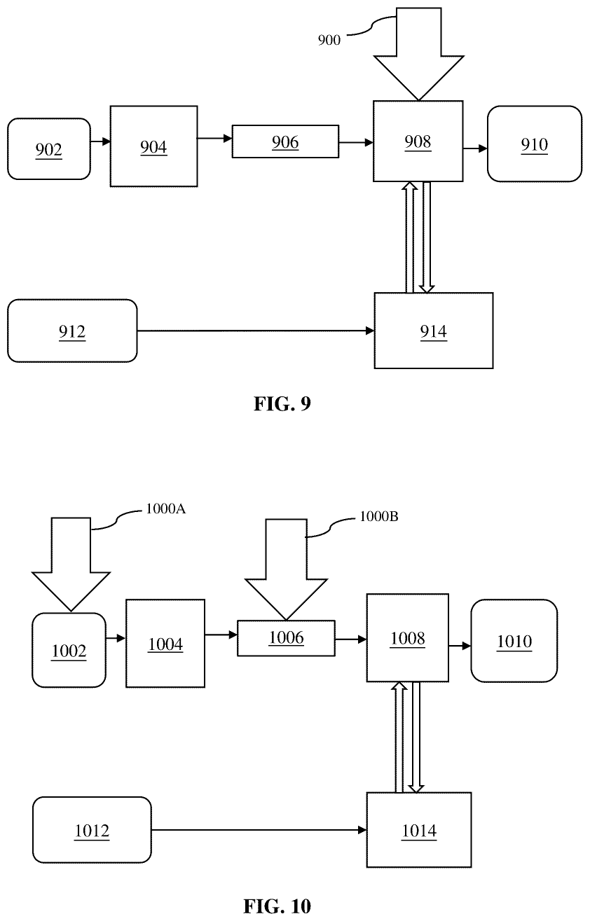

FIG. 9 illustrates an exemplary view of a method 900 for training recipient behavior in accordance with an implementation of the disclosure. The exemplary view depicts data 902, a large language model (LLM) layer 904, embedding 906, a Machine Learning (ML) model 908, expected outcomes 910, outcomes 912, and a parallel online training pipeline 914. The method concatenates fixed size embeddings into an input vector and a sum of all outcomes related to a specific recipient. The sum of outcomes can be discounted by time from time of each message to time of each outcome. The ML model 908 is trained to predict the expected outcomes 910 from the concatenated embeddings. Input includes a predefined type of data, e.g., recipient, context, and product in deterministic positions in the input vector. The ML model 908 is automatically trained based on business dynamics and recipient behavior to the extent that explaining data is available through recipient actions or inactions and without the need for the entity to perform any action. The ML model 908 is trained based on the recipient's behavior without a need for human intervention, feature engineering, or guidance. If there is no information in inputs, such as it is noise with respect to the outcomes 912, the ML model 908 is trained to ignore that data by assigning low weights for such inputs. The method enables scalability to any recipient, situation, or data. The method has powerful prediction accuracy and robustness. The ML model 908 is trained automatically with all the aspects of the recipient's behavior for predicting the outcomes (e.g., the expected outcomes 910).

FIG. 10 illustrates an exemplary view of a method (1000A, and 1000B) for caching data in accordance with an implementation of the disclosure. The exemplary view depicts data 1002, a large language model (LLM) layer 1004, embedding 1006, a Machine Learning (ML) model 1008, expected outcomes 1010, outcomes 1012, and a parallel online training pipeline 1014. The method may store all embeddings for each data 1002. The method may store a hash of the data 1002. If a hash has not changed, the method uses embedding 1006 instead of LLM processing. The LLM processing is 1000×-1million times more resource intensive (CPU/GPU/memory) than the ML model 1008. The method performs in near real-time as only changed data goes through the LLM layer 1004, and other data, i.e., cached embeddings only through the ML model 1008 which has a latency in the order of milliseconds. This enables real-time web page rendering, e.g., competitive performance <30 millisecond (ms) latency, and interactive voice e.g., competitive performance <300 ms latency. The method may store intermediate steps of calculation and determine a need for the intermediate steps when a recalculation is needed to eliminate the LLM processing.

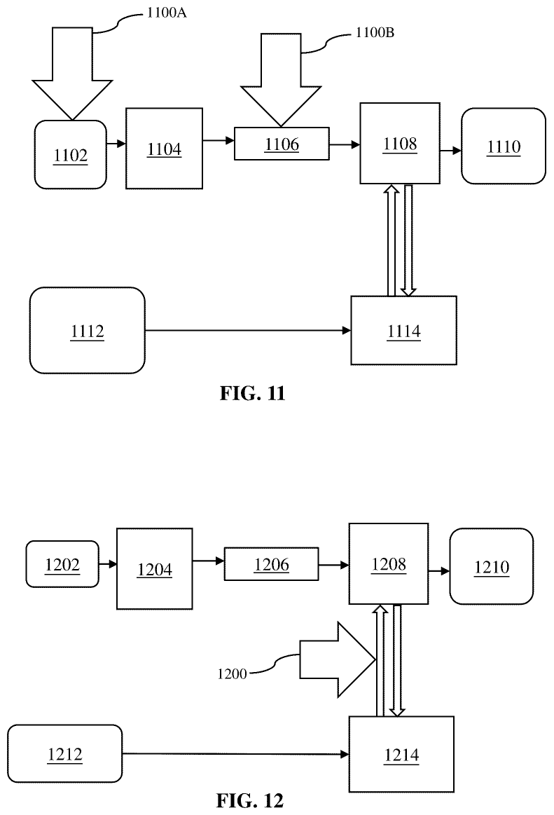

FIG. 11 illustrates an exemplary view of a method (1100A and 1100B) for approximation of embeddings in accordance with an implementation of the disclosure. The exemplary view depicts data 1102, a large language model (LLM) layer 1104, embedding 1106, a Machine Learning (ML) model 1108, expected outcomes 1110, outcomes 1112, and a parallel online training pipeline 1114. The method (i) uses LLM-calculated data, or (ii) searches for the nearest embedding using a KNN (K-Nearest Neighbors) or similar proximity search or clustering algorithm potentially using a lookup table within an available time limit. The lookup table may include a key, where the key is a combination of embedding of the previous version of the changed data and embedding of the latest change and a corresponding value is the resulting embedding. The method further calculates full LLM data in the background and updates the lookup table when needed once completed. The method performs user embedding based on a previous version of changed data and ignores a recent change within the available time limit. The method responds within a set maximum time-frame with available information at that time and supports real-time applications. For example, the set maximum time-frame can be 30-1000 ms; the set maximum time-frame can be 100 ms, 200 ms, 300 ms, 400 ms, 500 ms, 600 ms, 700 ms, 800 ms, 900 ms or 1000 ms. The method approximates the embeddings for data 1102 that cannot be processed in the time needed for the use case.

FIG. 12 illustrates an exemplary view of a method 1200 for continuous training of a Machine learning (ML) model 1208 in accordance with an implementation of the disclosure. The exemplary view depicts data 1202, a large language model (LLM) layer 1204, embedding 1206, the ML model 1208, expected outcomes 1210, outcomes 1212, and a parallel online training pipeline 1214. The method continuously, in parallel to serving a model, retrains the ML model 1208 with all previous data. The method decays older data over time to emphasize new information when available. When the ML model 1208 is updated, the method automatically deploys for serving. The method may promptly react to quick changes and trends in a market. The process of data decay facilitates the automatic replacement of older data, potentially obsolete data with more recent information. The ML model 1208 is continuously trained to accommodate all new information received. This changed information may include new inputs, new outcomes, and the absence of outcomes. Even if no new data has been received, an optimum model can be slightly different, as there is a different time passed from each data point. For example, no response to direct emails over extended time is new information that does not favor similar responses.

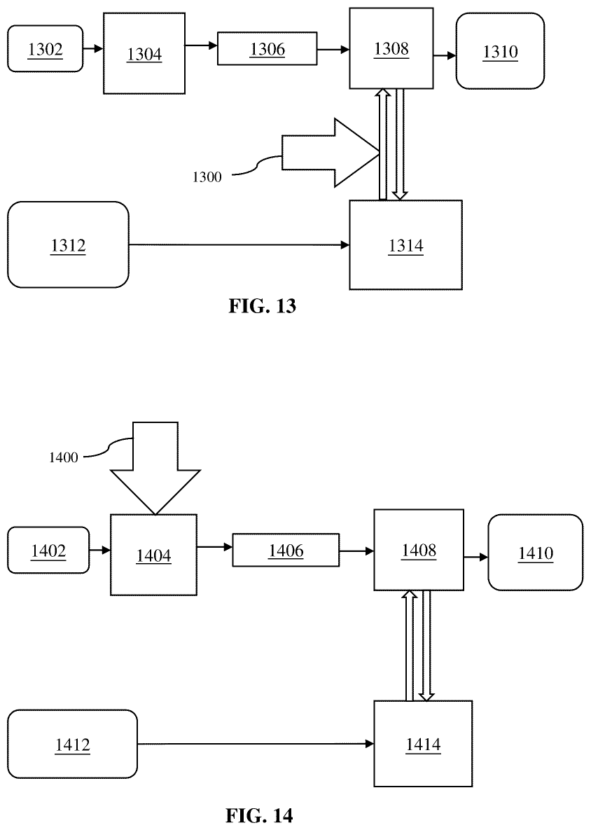

FIG. 13 illustrates an exemplary view of a method 1300 for continuous training optimization of a Machine Learning (ML) model 1308 in accordance with an implementation of the disclosure. The exemplary view depicts data 1302, a large language model (LLM) layer 1304, embedding 1306, the ML model 1308, expected outcomes 1310, outcomes 1312, and a parallel online training pipeline 1314. The method performs continuous training optimization to reduce a volume of the data 1302 to a fixed length. Optionally, fixed-length data can be trained in a predictable time. The method performs continuous training optimization to summarize embedding data, e.g., using clustering algorithms to represent multiple data points as one data point. For example, the clustering algorithms can be such as k-means. The one data point may be potentially weighted. The method performs continuous training optimization using any of the known clustering algorithms. For example, a training vector size is fixed as 1 million vectors and represents billions of vectors as their clustered 1 million means. Continuous retraining can be set to run at a constant time allowing consistent responsiveness of the method to changes in the environment, also over time even with increasing data. The method can be tuned between accuracy and responsiveness by adjusting a number of vectors representing training data. The method strategically drops out training data points that do not contribute to the learning.

FIG. 14 illustrates an exemplary view of a method 1400 for sampling of messages in accordance with an implementation of the disclosure. The exemplary view depicts data 1402, a large language model (LLM) layer 1404, embedding 1406, a Machine Learning (ML) model 1408, expected outcomes 1410, outcomes 1412, and a parallel online training pipeline 1414. The method uses a decoder LLM to sample a message data set (Δ) by prompting the message data set (Δ) to (i) generate alternative messages conditionally to all normalized inputs and (ii) explore different perspectives. The LLM layer 1404 not only focuses on a prompt but also adeptly considers the messages that are generated by the LLM layer 1404, paying attention to all the messages, thereby ensuring efficient and effective production of a well-distributed array of meaningful alternative messages. The method generates high-quality alternative messages which allow for exploring and selecting a desired message in any situation. In addition, while generating the alternative messages, the method may extract the most recent message, use ML to predict its outcome, and insert value tokens into the output token sequence. These value tokens are configured to instruct the LLM of the expected value of the most recent message. The value tokens may be expressed in natural language, as numerical values encoded into tokens, or as specials tokens reserved for expressing the value. The value tokens are further configured to inform the LLM on the merits of each previously generated message. As the LLM attends previously generated messages with their value tokens while generating the next message, the value tokens implicitly help the LLM to guide its search towards the desired distribution, for example in the simplest case towards the highest predicted value, constituting of a form of a MCMC method.

The method efficiently samples high-quality messages that can be tested using the prediction for their expected outcome 1410, enabling the method to choose the message with the desired outcome. An example of a desired outcome is outcome value expectation maximization, or a stochastic selection criteria such as a higher outcome, the more probably that message is selected by the method.

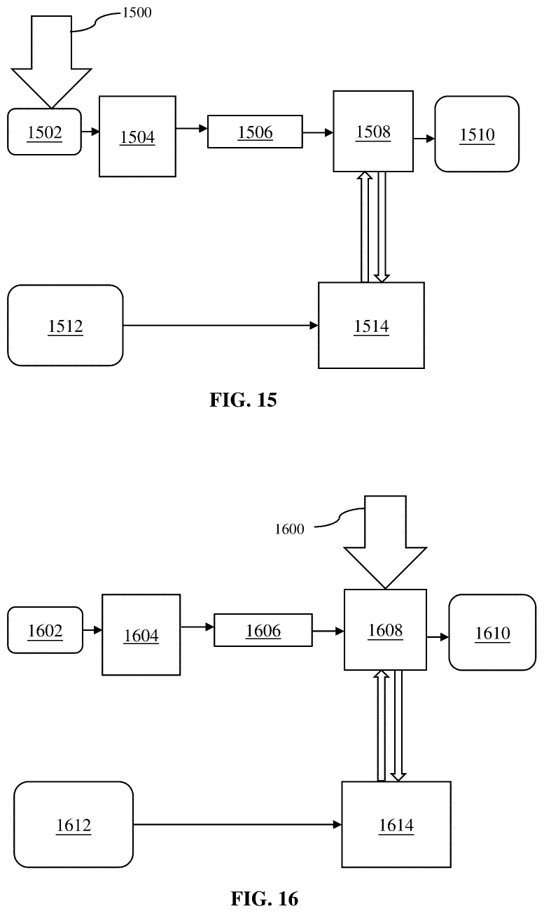

FIG. 15 illustrates an exemplary view of method 1500 for iterating data in accordance with an implementation of the disclosure. The exemplary view depicts data 1502, a large language model (LLM) layer 1504, embedding 1506, a Machine Learning (ML) model 1508, expected outcomes 1510, outcomes 1512, and a parallel online training pipeline 1514. The method enables a recipient to select any brand, product, deal, promotion, recipient, or context, and to evaluate all or a desire subset of combinations for their cumulative expected outcomes 1510 using a user interface. The method enables the recipient to perform optimized targeting, product recommendations, pricing, bundling, and new product introduction based on the optimized expected outcomes 1510, thereby enabling optimization of a business. The method generates combinations of the desired data points for an evaluation system and selects the best message and predicts the expected outcomes 1510. For example, the method analyzes one or more recipients and one or more products, selects 1000 with the highest expected outcome 1510, and sends an email and a message to each recipient individually to promote a customized product. For example, the method may write a product description of variants A and B of a new product and evaluate both against all recipients to determine the highest expected outcome 1510.

FIG. 16 illustrates an exemplary view of a method 1600 for privacy, compliance and universal training in accordance with an implementation of the disclosure. The exemplary view depicts data 1602, a large language model (LLM) layer 1604, embedding 1606, a Machine Learning (ML) model 1608, expected outcomes 1610, outcomes 1612, and a parallel online training pipeline 1614. The method does not train or fine-tune LLMs with entity data or recipient data. The method only trains the ML model 1608 which has already abstracted out sensitive data. The method uses out-of-the-shelf LLM models for feature extraction and message sampling. The LLM does not leak sensitive data, as they are not trained with the sensitive data and logically cannot contain such data. Training of the ML model 1608 can be based on multiple recipients and entities used together depending on commercial terms of usage. However, some recipients or entities may choose not to participate. This is possible because the training doesn't involve any sensitive data. For example, the ML model 1608 doesn't include information that a recipient A bought a red Tesla. Instead, the ML model 1608 may be trained based on information that a woman between 30 and 40 years old will choose red 37% of the time and other colors 63% of the time. When allowed, the method may train and accumulate ML level training across multiple recipients, e.g., hundreds of thousands of recipients, and multiple transactions, e.g., trillions of transactions, causing the method to train fundamental business dynamics of one or more entities.

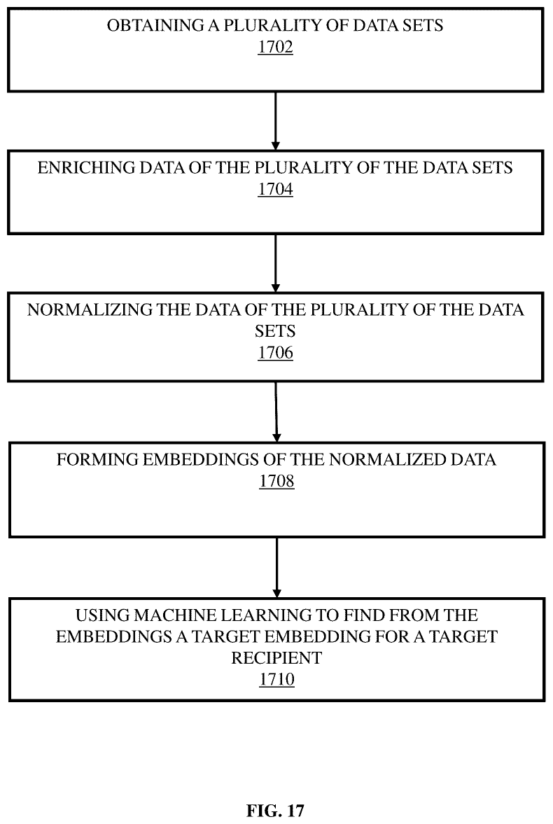

FIG. 17 are flow diagrams that illustrate a method for selecting data related to a recipient in accordance with an implementation of the disclosure. At a step 1702, one or more data sets are obtained. At a step 1704, data of the one or more data sets is enriched. At a step 1706, the data of the one or more data sets is normalized. At a step 1708, embeddings of the normalized data are formed. At a step 1710, machine learning is used to find from the embeddings a target embedding for a target recipient.

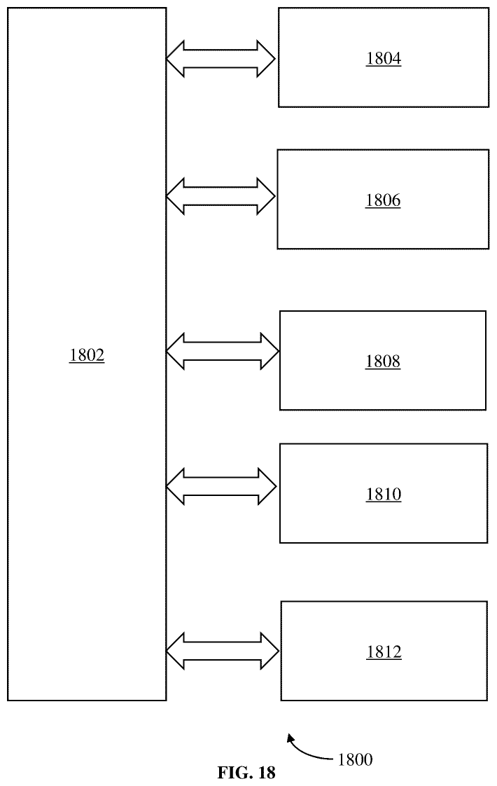

FIG. 18 is an illustration of a computer system (e.g., a system) in which the various architectures and functionalities of the various previous implementations may be implemented. As shown, the computer system 1800 includes at least one processor 1804 that is connected to a bus 1802, wherein the computer system 1800 may be implemented using any suitable protocol, such as Peripheral Component Interconnect, PCI-Express, Accelerated Graphics Port, AGP, Hyper Transport, or any other bus or point-to-point communication protocol. The computer system 1800 also includes a memory 1806.

Control logic (software) and data are stored in the memory 1806 which may take a form of random-access memory, RAM. In the disclosure, a single semiconductor platform may refer to a sole unitary semiconductor-based integrated circuit or chip. It should be noted that the term single semiconductor platform may also refer to multi-chip modules with increased connectivity which simulate on-chip modules with increased connectivity which simulate on-chip operation and make substantial improvements over utilizing a conventional central processing unit, CPU, and bus implementation. Of course, the various modules may also be situated separately or in various combinations of semiconductor platforms per the desires of a user.

The computer system 1800 may also include a secondary storage 1810. For example, the secondary storage 1810 may be a hard disk drive and a removable storage drive, representing a floppy disk drive, a magnetic tape drive, a compact disk drive, digital versatile disk, DVD drive, recording device, universal serial bus, and USB flash memory. The removable storage drives at least one of reads from and writes to a removable storage unit in a well-known manner.

Computer programs, or computer control logic algorithms, may be stored in at least one of the memory 1806 and the secondary storage 1810. Such computer programs, when executed, enable the computer system 1800 to perform various functions as described in the foregoing. The memory 1806, the secondary storage 1810, and any other storage are possible examples of computer-readable media.

In an implementation, the architectures and functionalities depicted in the various previous figures may be implemented in the context of the processor 1804, a graphics processor coupled to a communication interface 1812, an integrated circuit (not shown) that is capable of at least a portion of the capabilities of both the processor 1804 and a graphics processor, a chipset (namely, a group of integrated circuits designed to work and sold as a unit for performing related functions, and so forth).

Furthermore, the architectures and functionalities depicted in the various previous-described figures may be implemented in a context of a general computer system, a circuit board system, a game console system dedicated for entertainment purposes, an application-specific system. For example, the computer system 1800 may take the form of a desktop computer, a laptop computer, a server, a workstation, a game console, an embedded system.

Furthermore, the computer system 1800 may take the form of various other devices including, but not limited to a personal digital assistant, PDA device, a mobile phone device, a smart phone, a television, and so forth. Additionally, although not shown, the computer system 1800 may be coupled to a network (for example, a telecommunications network, a local area network, LAN, a wireless network, a wide area network, WAN such as the Internet, a peer-to-peer network, a cable network, or the like) for communication purposes through an I/O interface 1808.

It should be understood that the arrangement of components illustrated in the figures described are exemplary and that other arrangement may be possible. It should also be understood that the various system components (and means) defined by the claims, described below, and illustrated in the various block diagrams represent components in some systems configured according to the subject matter disclosed herein. For example, one or more of these system components (and means) may be realized, in whole or in part, by at least some of the components illustrated in the arrangements illustrated in the described figures.

In addition, while at least one of these components are implemented at least partially as an electronic hardware component, and therefore constitutes a machine, the other components may be implemented in software that when included in an execution environment constitutes a machine, hardware, or a combination of software and hardware.

Although the disclosure and its advantages have been described in detail, it should be understood that various changes, substitutions, and alterations can be made herein without departing from the spirit and scope of the disclosure as defined by the appended claims.

1. A method for selecting data related to a recipient, the method comprising:
obtaining one or more data sets;
processing the data within the one or more data sets to extract and normalize content into normalized attributes;
generating vectorized embeddings of the normalized attributes;
producing an output data set comprising one or more candidate outputs for interaction with the recipient;
generating vectorized embeddings of the one or more candidate outputs;
comparing the vectorized embeddings of the normalized attributes and the vectorized embeddings of the one or more candidate outputs; and
selecting zero or more candidate outputs from the output data set based on a predefined selection criterium applied to the comparison results.

2. The method according to claim 1, wherein the method comprises repeating the steps iteratively to account for changes in the one or more data sets.

3. The method according to claim 1, wherein the method further comprises enriching the data of the one or more data sets using external data sources or internal data sources.

4. The method according to claim 3, wherein enriching the one or more data sets includes at least one of: search engine search, social media search, web scraping, or database querying.

5. The method according to claim 1, wherein the one or more data sets comprise customer data comprising at least one of: gender, age, address, purchase history, communication history, credit rating, relationship status, or income level.

6. The method according to claim 1, wherein the one or more data sets comprise customer interaction and performance metrics comprising at least one of: purchase data, click-through data, satisfaction metrics, lifetime value, or conversion data.

7. The method according to claim 1, wherein the method further comprises assigning weights to data within the one or more data sets based on the time at which the data was generated or occurred.

8. The method according to claim 1, wherein the output data set is generated using an AI model comprising at least one of the following: a large language model, a generative AI model, a machine learning model, a transformer model, a diffusion model, or a deep neural network.

9. The method according to claim 8, wherein the AI model is configured to use at least one data set of the one or more data sets to generate the output data set.

10. The method according to claim 1, wherein the method further comprises one or more of the following:
using the desired output data for communication with the recipient in at least one of: email, text message, or web page;
using in the normalization of unstructured data at least one AI model comprising at least one of the following: a large language model, a generative AT model, a machine learning model, a transformer model, a diffusion model, or a deep neural network;
handling missing data by generating embeddings for the missing data using at least one AT model comprising at least one of the following: a large language model, a generative AT model, a machine learning model, a transformer model, a diffusion model, or a deep neural network;
receiving one or more outcome data sets and conditioning an AT model comprising at least one of the following: a large language model, a generative AT model, a machine learning model, a transformer model, a diffusion model, or a deep neural network using at least one of the outcome data sets and at least one of the one or more data sets;
tracking information associated with the recipient and incorporating the tracked information into the one or more data sets;
using at least one of the one or more data sets for conditioning an AI model comprising at least one of the following: a large language model, a generative AI model, a machine learning model, a transformer model, a diffusion model, or a deep neural network;
anonymizing or pseudonymizing recipient-specific data in the one or more data sets;
obtaining feedback from the recipient and incorporating the feedback into the one or more data sets;
performing at least one of the normalization steps or the embedding step using one or more of batch processing, asynchronous processing, or parallel processing to efficiently handle large data sets;
segmenting recipients based on the one or more data sets into groups of recipients with similar characteristics;
updating the AI model by training it incrementally using newly obtained data without performing complete retraining;
forming clusters of similar embeddings to optimize the comparison and selection of the desired output data;
storing embeddings of frequently accessed data to reduce computational overhead during repeated comparisons;
dynamically updating the selected desired output data during ongoing interactions with the recipient to provide real-time recommendations or responses.

11. The method according to claim 1, wherein the one or more data sets comprise at least two types of data selected from text, images, video, or audio.

12. A system for selecting data related to a recipient, the system comprising:
one or more processors configured to perform the steps of the method according to claim 1;
a data acquisition module configured to obtain one or more data sets;
a data normalization module configured to process the data within the one or more data sets to extract and normalize content into a normalized attributes;
an embedding module configured to generate vectorized embeddings of the normalized attributes;
a data generation engine configured to produce an output data set comprising one or more candidate outputs for interaction with the recipient;
a comparison module configured to compare the vectorized embeddings of the normalized attributes and the vectorized embeddings of the one or more candidate outputs; and
a selection module configured to select zero or more candidate outputs from the output data set based on a predefined selection criterium applied to the comparison results.

13. The system according to claim 12, wherein the system further comprises one or more of the following:
a feedback module configured to dynamically adjust embeddings based on real-time interactions with the recipient;
a storage module configured to store embeddings of frequently accessed data to reduce computational overhead during repeated comparisons; or
a dynamic update module configured to adjust the selected desired output data during ongoing interactions with the recipient to provide real-time recommendations or responses.

14. The system according to claim 12, wherein the data normalization module and the embedding module are configured to operate in parallel to improve scalability and processing efficiency for large data sets.

15. A machine-learning model for selecting data related to a recipient, for use in the method of claim 1, wherein the machine-learning model comprises structural components configured to generate the recipient related output data, and wherein the machine-learning model is trained to:
process vectorized embeddings of normalized attributes and vectorized embeddings of output data sets;
compare the vectorized embeddings of the normalized attributes with the vectorized embeddings of the output data sets; and
identify desired output data related to the recipient based on the comparison.

16. A computer-implemented method of training the machine-learning model of claim 15, the method comprising:
obtaining one or more data sets;
processing the obtained one or more the data sets to form normalized data;
forming embeddings of the normalized data;
forming a training data set by associating the embeddings with predefined outcome data sets;
training the machine-learning model using the training data set to generate an output data related to a recipient; and
updating the machine-learning model using feedback data derived from prior output data.

17. A computer-implemented method of generating a training data set for the machine-learning model of claim 15, the method comprising:
obtaining one or more data sets;
obtaining one or more outcome data sets;
processing the obtained one or more data sets to form normalized data;
forming embeddings of the normalized data;
determining association between the embeddings of the normalized data and one or more outcome data sets;
creating a training data set comprising the embeddings and associated outcome data sets.

18. A training data set for use in the method of claim 15 of training the machine-learning model comprising:
normalized embeddings derived from a one or more data sets;
outcome data sets associated with the embeddings.

19. A use of the method of claim 1 for at least one of:
generating recipient-specific recommendations in customer marketing;
personalizing marketing messages based on recipient-specific preferences and behaviors;
recommending best products and services based on customer data;
determining the next best action with respect to a customer;
personalizing web site elements to a specific customer;
personalizing emails to a specific customer;
U personalizing text messages to a specific customer.

20. A computer program for selecting data related to a recipient, the computer program comprising instructions which, when executed by a processor, cause the processor to perform the method according to claim 1.
